(19) United States
(12) Patent Application Publication
(10) Pub. No.: US 2010/0268867 A1
(43) Pub. Date: Oct. 21, 2010

(54) METHOD AND APPARATUS FOR UPDATING FIRMWARE AS A BACKGROUND TASK

(75) Inventors: Yevgen Gyl, Tampere (FI); Jani Hyvonen, Tampere (FI)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/443,481

(22) PCT Filed: Sep. 29, 2006
(86) PCT No.: PCT/IB2006/003872

§ 371 Date: Jun. 23, 2010

(51) Int. Cl. G06F 12/02

(52) U.S. Cl. 711/103; 711/165; 711/E12.002; 711/E12.008; 717/168

(57) ABSTRACT

A method comprising storing data in a first memory that includes a first portion that has read-only access during a normal mode of operation; and during a update mode of operation: copying at least one data structure from the first memory to a second memory where it is available for use during the update mode; and updating data in the first portion of the first memory.

### FIELD OF THE INVENTION

Embodiments of the present invention relate to firmware update. In particular, some relate to firmware updates over the air.

### BACKGROUND TO THE INVENTION

Firmware over the air (FOTA) describes a procedure for remotely updating software in a memory to which the device in normal operation has read-only access and not write access. Patches to existing software or new software can be downloaded to the read-only memory of a remote device via radio communications (over the air). This enables the updating of remote devices, such as mobile cellular telephones, without the need to bring the remote device to a service centre.

The updating of software on a device using FOTA may take a considerable amount of time and the device is unavailable for use during that time. This may be frustrating to a user, particularly if they have not initiated the FOTA update.

### BRIEF DESCRIPTION OF THE INVENTION

According to one embodiment of the invention there is provided a method comprising: storing data in a first memory that includes a first portion that has read-only access during a normal mode of operation; and during a update mode of operation: copying at least one data structure from the first memory to a second memory where it is available for use during the update mode; and updating data in the first portion of the first memory.

According to another embodiment of the invention there is provided a computer program comprising computer program instructions for: changing a mode of operation of a device from a normal mode of operation in which a first portion of a first memory has read-only access to a second mode of operation in which the first portion of the memory is updatable; and, during the update mode of operation, for enabling copying of at least one data structure from a first memory to a second memory and updating of data in the first portion of the first memory.

According to another embodiment of the invention there is provided an apparatus comprising: a first memory that includes a first portion for read-only access during a normal mode of operation; a second memory for storing data for use during an update mode of operation; and an update controller arrangement for controlling the transition from the normal mode to the update mode, for enabling the transfer of data for use during the update mode from the first memory to the second memory and for enabling updating of at least a part of the first portion of the first memory during the update mode.

### BRIEF DESCRIPTION OF THE DRAWINGS

For a better understanding of the present invention reference will now be made by way of example only to the accompanying drawings in which:

FIG. 1 schematically illustrates an electronic device or apparatus;

FIG. 2 is a schematic illustration of a semi-permanent memory; and

FIG. 3 is a process flow diagram illustrating the operation of the device during an update to the semi-permanent memory.

### DETAILED DESCRIPTION OF EMBODIMENTS OF THE INVENTION

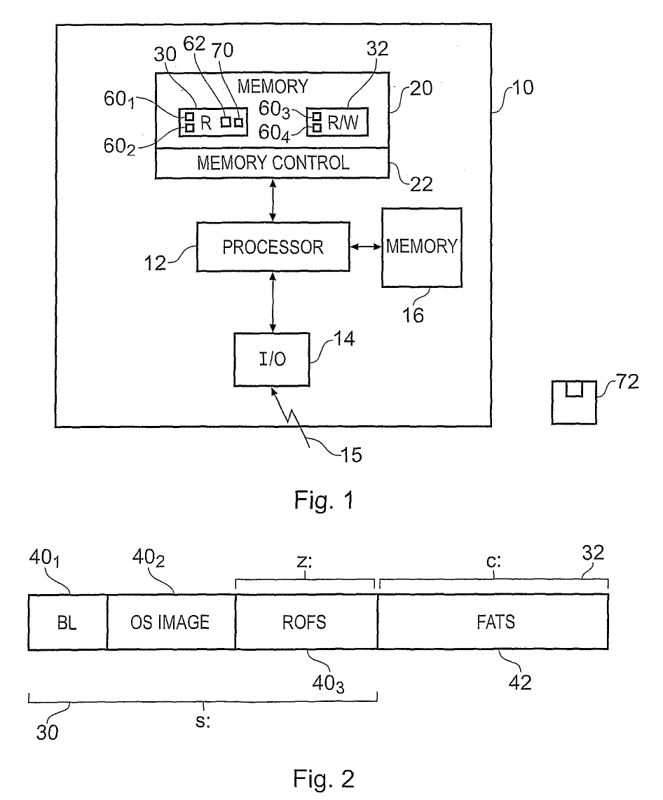

FIG. 1 schematically illustrates an electronic device or apparatus 10 comprising a processor (or processors) 12, a memory 20 that retains data when the device is switched-off but which can be written to (semi-permanent storage), a memory access controller 22 for controlling access to the semi-permanent memory 20, a fast access memory 16 and an input port 14 for receiving update package(s) 15 for updating at least a portion of the semi-permanent memory 20.

The electronic device 10 may be any suitable electronic device that enables the update of read-only data in a memory.

The input port 14 may include a radio receiver (and possibly a radio transmitter). The update of the read-only data may be achieved by receiving an update package or packages via the radio receiver or some other interface such as a mass storage interface, for example, a secure digital memory card or similar. As a non-limiting example, the device 10 may operate as a mobile cellular telephone or a module for operation in a mobile cellular telephone network and the update package(s) would be received from the mobile cellular telephone network.

The semi-permanent memory 20 has, in this example, a read-only section 30 for storing firmware i.e. software or files that are accessible to the device 10 on a read-only basis during a normal mode of operation.

The semi-permanent memory 20 has, in this example, a read/write section 32 for storing user data including software i.e. data that is accessible for reading and for modification during a normal mode of operation.

The memory access controller 22 controls access to the semi-permanent memory 20. In particular, it controls when data can be read from the memory 20 and the portions of the memory 20 to which data may be written.

The fast access memory 16 may be a random access type memory e.g. a RAM. It is typically used to cache data read from the semi-permanent memory 20 or data for writing to the semi-permanent memory 20. Although in the illustrated example, the fast access memory 16 is connected to the memory 20 and it access controller 22 via the processor(s) 12 in other embodiments direct memory access may be used.

In one embodiment the semi-permanent memory 20 is a NAND type flash memory. NAND flash memories cannot support execute-in-place. When executing software from NAND memories, memory contents must first be paged into the fast access memory 16 and executed there. A NAND type flash memory is accessed like a hard disk. It enables the rewriting of data quickly and repeatedly.

An schematic illustration of a semi-permanent memory 20 is illustrated in FIG. 2. In the example illustrated in FIG. 2, the semi-permanent memory 20 is divided into a read-only section 30 which is mapped to drive S and a read/write section 32 which is mapped to drive C. In other implementations, there may be multiple read-only sections (RO) and multiple read/write sections (RW). The different RO and RW portions may be mixed together i.e. interleaved. The RO and RW portions may be separately partitioned.

The read-only section 30 comprises one or more read-only partitions 40 and the read/write section 32 comprises one or more read/write partitions 42.

The read-only partition(s) 40, in the example illustrated, include a boot-loader 40₁ for loading the operating system (OS) on booting-up the device 10, the core operating system (OS) image 40₂, and a read-only file system (ROFS) 40₃ which is mapped to drive Z. The read-only partitions 40, in a normal mode of operation, can be read but cannot be modified.

The read/write partition(s) 42, in the example illustrated, include a read/write file system such as a file allocation table (FAT) system for the storage of user data.

The operating system may be a Symbian operating system.

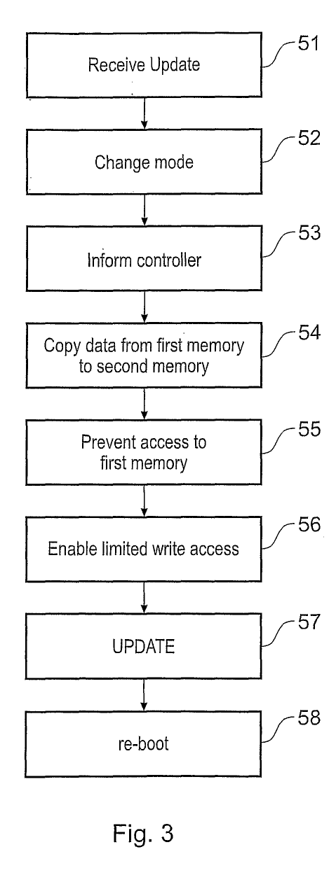

The operation of the device 10 during an update to the semi-permanent memory 20 is illustrated in FIG. 3. The device has a normal mode of operation in which the status of the read-only section 30 of the memory 20 is such that read access only is available to the read-only section 30. The device 10 has an update mode of operation in which the status of the read-only section 30 of the memory 20 is such that write access is available to selected portions of the read-only section 30 to update them. The ‘selected portions’ may specify a portion or the whole of the read-only section or multiple read-only sections 30.

The method 50 comprises a series of sequential blocks that may be steps in a process or code portions in a computer program, such as OS image 40₂ or a separate program 70.

At block 51, an update package 15 is received at input port 14

At block 52, the processor 12 detects the receipt of an update package 15 and changes the mode of the device 10 from ‘normal’ to ‘update’.

At block 53, the processor 12 informs the memory access controller 22 that the update mode has been entered.

At block 54, the memory access controller 22 copies data structures 60₁, 60₂, 60₃ and 60₄ from the memory 20 to the fast access memory 16 so that they are available for use during the update procedure. The data structures 60 may, for example, be executable files from either the read-only section 30 of the semi-permanent memory 20 or from the read/write section 32 of the semi-permanent memory 32.

The identity of some or all of the data structures which are copied may be permanently predefined or may be variably predefined or a combination of permanently and variably predefined. For example, it may be specified that the data structures for executing specified key applications must be copied. For example, a user may be able to specify applications for which the associated data structures must be copied. ‘Pre-defined’ in this context means defined before the method 50 has started rather than as a part of the method.

The identity of some or all of the data structures which are copied may be defined in dependence upon the update package 15. If the update package 15 specifies an update to particular applications then the data structures 60 for those applications may be prevented from being copied. If the update package 15 specifies a particular section of the memory 20 then the data structures 60 for applications located in that section may be prevented from being copied.

In this way, a user may have access to useful applications such as those that provide for making and/or receiving calls, sending and/or receiving messages SMS, playing music etc. This may give the impression that the firmware update occurs as a background task.

At block 55, the memory controller 22 prevents further access to parts of the memory including an update area 62 in the read-only section 30 of the memory 20 to prevent automatic loading of data to the fast access memory 16.

At block 56, the memory controller 22 enables specific read/write access to the read-only section 30 of the memory 20, at only the update area 62 defined by the update package 15, by converting the status of the update area 62 temporarily from read-only to read/write. The memory controller 22 may continue to allow read/write access to read/write section(s) 32.

At update block 57, the content of the update package (possibly after processing) is then written to the appropriate sections of the memory 20 which will include the update area 62 of the RO section(s) 30 and may include RW section(s) 32.

At block 58, the method ends by re-booting the device 10.

During the method 50, at block 54, an update application for controlling the method 50 may be copied to the fast access memory 16. The update application logs the progress of the method 50. If the method is not complete because, for example, of powering off the device, on restarting the device the boot-up starts in the update mode at the point in the method where termination occurred.

The description refers to sections, portions and partitions of the memories. It should be understood that these are typically logically divisions of a physical memory but in some embodiments may be physical divisions.

The memory 20 stores computer program instructions 70 that control the operation of the electronic device 10 when loaded into the processor 12. The computer program instructions 70 provide the logic and routines that enables the electronic device to perform the methods illustrated in FIG. 3.

The computer program instructions may arrive at the electronic device 10 via an electromagnetic carrier signal or be copied from a physical entity 72 such as a computer program product, a memory device or a record medium such as a CD-ROM or DVD.

Although embodiments of the present invention have been described in the preceding paragraphs with reference to various examples, it should be appreciated that modifications to the examples given can be made without departing from the scope of the invention as claimed. For example, a system may comprise more that one subsystem, where a subsystem has its own (physically or logically) processor and firmware in one or more memories. Examples of subsystems are: telephony subsystem, modem subsystem, Bluetooth subsystem, WLAN subsystem, digital camera subsystem, RFID subsystem etc. One subsystem, such as the one illustrated in FIG. 1, may be a ‘master’ controlling the update process for the whole system. The master may respond to the content of the update package by disabling a first set of subsystems while a firmware update for a first subsystem is in progress. The first set will contain the first subsystem but may also include other subsystems. For example, if a firmware update is in progress for a modem subsystem then the modem subsystem and the telephony subsystem may be disabled for the duration of the update. A disabled subsystem may be enabled after the firmware update affecting that subsystem has completed or after all firmware updates specified by the update package 15 have been completed.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

I/we claim:

1. A method comprising:
storing data in a first memory that includes a first portion that has read-only access during a normal mode of operation; and
during an update mode of operation: copying at least one data structure from the first memory to a second memory where it is available for use during the update mode; and
updating data in the first portion of the first memory.

2. A method as claimed in claim 1, wherein the at least one data structure is an executable file that provides an application during the update mode.

3. A method as claimed in claim 1, further comprising enabling a user to specify one or more data structures for copying to the second memory during the update mode.

4. A method according to claim 1, further comprising, during the update mode, preventing access to the first memory other than for said copying and updating.

5-9. (canceled)

10. A method according to claim 1, wherein the first section of the first memory has one or more partitions.

11-36. (canceled)

37. A method according to claim 10, wherein updating data in the first section of the first memory, comprises receiving update package(s) and updating data in selected portions of the first section of the first memory, where the update package(s) include data to be written to the selected portions of the first section of the first memory.

38. A method according to claim 37, wherein the at least one data structure is dependent upon the update package(s).

39. A method according to claim 1, wherein the step of copying further comprises copying an update application to the second memory for restarting the update procedure if it is terminated.

40. A computer program comprising computer program instructions for:
changing a mode of operation of a device from a normal mode of operation in which a section of a first memory has read-only access to an update mode of operation in which the section of the memory is updatable; and
during the update mode of operation, enabling copying of at least one data structure from a first memory to a second memory and updating of data in the section of the first memory, enabling a user to specify the one or more data structures for copying to the second memory, preventing access to the first memory, copying an update application to the second memory for restarting the update procedure if it is terminated.

41. An apparatus comprising:
a first memory that includes a first section configured for read-only access during a normal mode of operation;
a second memory configured to store data for use during an update mode of operation; and
an update controller arrangement configured to control the transition from the normal mode to the update mode, to enable the transfer of data for use during the update mode from the first memory to the second memory and enable updating of at least a part of the first section of the first memory during the update mode.

42. An apparatus according to claim 41 wherein the update controller arrangement comprises a processor and memory access controller for the first memory.

43. An apparatus according to claim 41, wherein the data is an executable file that provides an application during the update mode.

44. An apparatus according to claim 41, further configured to during the update mode prevent access to the first memory other than for said transferring of data during the update mode from the first memory to the second memory and for said updating of at least a part of the first section of the first memory during the update mode.

45. An apparatus according to claim 41, further configured to receive update package(s) identifying the at least a part of the first section of the first memory.

46. An apparatus according to claim 45, wherein the data for use during the update mode is dependent upon update package(s), where the update package(s) include data to be written to the at least a part of the first section of the first memory.

47. An apparatus according to claim 41, wherein the update controller arrangement is configured to enable the transfer of an update application to the second memory for restarting the update procedure if it is terminated.

48. An apparatus according to claim 41, wherein the first memory is a NAND type flash memory.

49. An apparatus according to claims 41, wherein the first memory has a second section for storing data that is accessible for reading and writing during the normal mode of operation.

50. An apparatus according to claim 41, wherein the second memory is a random access type memory.

51. An apparatus according to claim 41 comprising a mobile terminal.
